(19) United States
(12) Patent Application Publication
(10) Pub. No.: US 2025/0355872 A1
(43) Pub. Date: Nov. 20, 2025

(54) DEVICE, METHOD AND NON-TRANSITORY COMPUTER-READABLE STORAGE MEDIUM

(71) Applicants: Preferred Networks, Inc., Tokyo (JP); ENEOS Corporation, Tokyo (JP)

(72) Inventors: So TAKAMOTO, Tokyo (JP); Akihide HAYASHI, Tokyo (JP)

(73) Assignees: Preferred Networks, Inc., Tokyo (JP); ENEOS Corporation, Tokyo (JP)

(21) Appl. No.: 19/209,494

(22) Filed: May 15, 2025

(30) Foreign Application Priority Data
May 16, 2024 (JP) 2024-080204

(51) Int. Cl. G06F 16/2453

(52) U.S. Cl. CPC G06F 16/24542

(57) ABSTRACT

A device according includes at least one memory, and at least one processor. The at least one processor is configured to: generate a score by using a neural network; calculate a derivative value of the score by applying back propagation to the neural network; set a search condition for an optimal solution of the score by using an index indicating an uncertainty of the score, the derivative value of the score, and the score; and determine the optimal solution of the score by a gradient method using the search condition.

### CROSS-REFERENCE TO RELATED APPLICATIONS

This application is based upon and claims the benefit of priority from Japanese Patent Application No. 2024-080204, filed on May 16, 2024; the entire contents of all of which are incorporated herein by reference.

### BACKGROUND OF THE INVENTION

### 1. Field of the Invention

An embodiment of the present disclosure relates to a device, a method and a non-transitory computer-readable storage medium.

### 2. Description of the Related Art

Conventionally, various methods are known as an optimization technique. For example, when a line search is used in a gradient method as an optimization technique, convergence is expected. Specifically, in an optimization technique called a gradient method such as a quasi-Newton method, efficient optimization is performed by using, in addition to a value which is a target of optimization (hereinafter referred to as target value), the gradient (derivative, hereinafter referred to as derivative value) of the target value.

However, in a case where the precision of the floating-point numbers related to the target values is low, when the computations performed to calculate the target values before optimization are not deterministic, the target values may contain uncertainty. At this time, the original quasi-Newton method may not operate correctly.

On the other hand, in a case where a learned neural network is used as the calculation of the target value, the derivative value of the target value may be calculated by back propagation with respect to the neural network. At this time, even when the precision of the floating-point number related to the target value is low, it is known that the precision of the derivative value is better than that of the target value.

Related techniques are described in “Towards universal neural network potential for material discovery applicable to arbitrary combination of 45 elements” Nature Communications volume 13, Article number: 2991 (2022), URL: https://www.nature.com/articles/s41467-022-30687-9, So Takamoto, Chikashi Shinagawa, Daisuke Motoki, Kosuke Nakago, Wenwen Li, Iori Kurata, Taku Watanabe, Yoshihiro Yayama, Hiroki Iriguchi, Yusuke Asano, Tasuku Onodera, Takafumi Ishii, Takao Kudo, Hideki Ono, Ryohto Sawada, Ryuichiro Ishitani, Marc Ong, Taiki Yamaguchi, Toshiki Kataoka, Akihide Hayashi, Nontawat Charoenphakdee, Takeshi Ibuka, and Practical methods of optimization (2nd ed.), Fletcher, Roger (1987), New York: John Wiley & Sons, ISBN 978-0-471-91547-8.

An object of the present disclosure is to realize optimization of an output value with high precision even when precision of the output value from a neural network is low.

### SUMMARY OF THE INVENTION

A device according to the present disclosure includes at least one memory, and at least one processor. The at least one processor is configured to: generate a score by using a neural network; calculate a derivative value of the score by applying back propagation to the neural network; set a search condition for an optimal solution of the score by using an index indicating an uncertainty of the score, the derivative value of the score, and the score; and determine the optimal solution of the score by a gradient method using the search condition.

### BRIEF DESCRIPTION OF THE DRAWINGS

FIG. 1 is a block diagram illustrating an example of a hardware configuration of an inference device according to an embodiment;

FIG. 2 is a diagram illustrating an example of functional blocks in a processor according to the embodiment;

FIG. 3 is a flowchart illustrating an example of a procedure of optimization processing according to the embodiment; and

FIG. 4 is a diagram illustrating an example of functional blocks in a processor in a learning device according to the embodiment.

### DETAILED DESCRIPTION OF THE PREFERRED EMBODIMENTS

Hereinafter, embodiments will be described in detail with reference to the drawings.

### EMBODIMENT

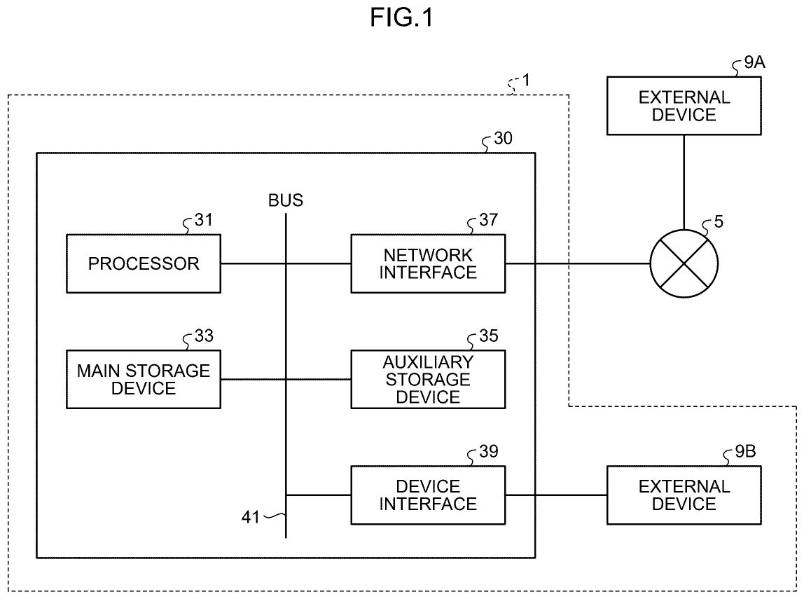

FIG. 1 is a block diagram illustrating an example of a hardware configuration of an inference device 1 according to an embodiment. As illustrated in FIG. 1, the inference device 1 may be connected to an external device 9A via a communication network 5. Furthermore, the inference device 1 may include an external device 9B connected via a device interface 39. For example, the inference device 1 may input information indicating a physical system which is an inference target. The information indicating the physical system which is an inference target is, for example, a structure of a substance by a plurality of atoms (coordinates of atoms, atomic bonding state, and the like), a structure such as a building (coordinates, stress, and the like of a structure), a fluid (position, viscous, flow rate, and the like of virtual particles), information regarding a closed area related to global illumination (light source, position of wall, position of arrangement), and the like.

Hereinafter, for the sake of concrete explanation, it is assumed that the information indicating the physical system, which is an inference target, is information indicating an atomic structure. At this time, the inference device 1 may input a notation indicating a structure of a substance including a plurality of atoms input by the user. The substance is, for example, a molecule. The substance is not limited to a molecule, and may be various crystals or the like. The notation is, for example, simplified molecular input line entry system (SMILES) notation input by the user in relation to the substance. The SMILES notation represents, for example, information of a certain molecule (information on atoms and how they are connected) by a certain rule. For example, the SMILES notation is particle size information in which four hydrogen (H) atoms are connected to one carbon (C) atom in the case of methane.

Note that the notation is not limited to the SMILES notation, and may be another known notation as long as the substance can be uniquely identified. Hereinafter, for the sake of concrete explanation, it is assumed that information input by the user via an input device to be described later is information (hereinafter referred to as SMILES information) corresponding to SMILES notation.

The inference device 1 includes a computer 30 and an external device 9B connected to the computer 30 via the device interface 39. As an example, the computer 30 includes a processor 31, a main storage device (memory) 33, an auxiliary storage device (memory) 35, a network interface 37, and the device interface 39. The inference device 1 may be realized as the computer 30 in which the processor 31, the main storage device 33, the auxiliary storage device 35, the network interface 37, and the device interface 39 are connected via a bus 41.

The computer 30 illustrated in FIG. 1 includes one component, but may include a plurality of the same components. Furthermore, although FIG. 1 illustrates one computer 30, software may be installed in a plurality of computers, and each of the plurality of computers may execute the same or different processing of the software. In this case, there may be a form of distributed computing in which each computer communicates via the network interface 37 or the like to execute processing. That is, the inference device 1 in the present embodiment may be configured as a system that realizes various functions described later by one or a plurality of computers executing commands stored in one or a plurality of storage devices. Furthermore, the information transmitted from the terminal may be processed by one or a plurality of computers provided on the cloud, and the processing result may be transmitted to a terminal such as a display device (display unit) corresponding to the external device 9B.

Various operations of the inference device 1 in the present embodiment may be executed in parallel processing using one or a plurality of processors or using a plurality of computers via a network. In addition, various operations may be distributed to a plurality of arithmetic cores in the processor and executed in parallel processing. In addition, some or all of the processing, means, and the like of the present disclosure may be executed by at least one of a processor and a storage device provided on a cloud that can communicate with the computer 30 via a network. As described above, various types described later in the present embodiment may be in the form of parallel computing by one or a plurality of computers.

The processor 31 may be an electronic circuit (a processing circuit, a processing circuit, a processing circuitry, a central processing unit (CPU), a graphics processing unit (GPU), a field programmable gate array (FPGA), an application specific integrated circuit (ASIC), or the like) including a control device and an arithmetic device of the computer 30. Furthermore, the processor 31 may be a semiconductor device or the like including a dedicated processing circuit. The processor 31 is not limited to an electronic circuit using an electronic logic element, and may be realized by an optical circuit using an optical logic element. Furthermore, the processor 31 may include an arithmetic function based on quantum computing.

The processor 31 can perform arithmetic processing based on data and software (program) input from each device or the like of the internal configuration of the computer 30 and output an arithmetic result and a control signal to each device or the like. The processor 31 may control each component constituting the computer 30 by executing an operating system (OS), an application, or the like of the computer 30.

The inference device 1 in the present embodiment may be realized by one or a plurality of processors 31. Here, the processor 31 may refer to one or more electronic circuits disposed on one chip, or may refer to one or more electronic circuits disposed on two or more chips or two or more devices. When a plurality of electronic circuits is used, the electronic circuits may communicate in a wired or wireless manner.

The main storage device 33 is a storage device that stores instructions executed by the processor 31, various types of data, and the like, and information stored in the main storage device 33 is read by the processor 31. The auxiliary storage device 35 is a storage device other than the main storage device 33. Note that these storage devices mean any electronic components capable of storing electronic information, and may be semiconductor memories. The semiconductor memory may be either a volatile memory or a nonvolatile memory. The storage device for storing various types data used in the inference device 1 according to the present embodiment may be realized by the main storage device 33 or the auxiliary storage device 35, or may be realized by a built-in memory built in the processor 31. For example, the storage unit in the present embodiment may be realized by the main storage device 33 or the auxiliary storage device 35.

A plurality of processors may be connected (coupled) or a single processor 31 may be connected to one storage device (memory). A plurality of storage devices (memories) may be connected (coupled) to one processor. In a case where the inference device 1 in the present embodiment includes at least one storage device (memory) and a plurality of processors connected (coupled) to the at least one storage device (memory), at least one processor among the plurality of processors may include a configuration in which the at least one processor is connected (coupled) to the at least one storage device (memory). Furthermore, this configuration may be implemented by a storage device (memory) included in a plurality of computers and the processor 31. Further, a storage device (memory) may be integrated with the processor 31 (for example, a cache memory including an L1 cache and an L2 cache).

The network interface 37 is an interface for connecting to the communication network 5 wirelessly or by wire. As the network interface 37, an appropriate interface such as one conforming to an existing communication standard may be used. The network interface 37 may exchange information with the external device 9A connected via the communication network 5. Note that the communication network 5 may be any of a wide area network (WAN), a local area network (LAN), a personal area network (PAN), or the like, or a combination thereof, as long as information is exchanged between the computer 30 and the external device 9A. Examples of the WAN include the Internet, examples of the LAN include IEEE 802.11 and Ethernet (registered trademark), and examples of the PAN include Bluetooth (registered trademark) and near field communication (NFC).

The device interface 39 is an interface such as a universal serial bus (USB) directly connected to an output device such as a display device, an input device, and the external device 9B. Note that the output device may include a speaker or the like that outputs sound or the like.

The external device 9A is a device connected to the computer 30 via a network. The external device 9B is a device directly connected to the computer 30.

As an example, the external device 9A or the external device 9B may be an input device (input unit). The input device is, for example, a device such as a camera, a microphone, motion capture, various sensors, a keyboard, a mouse, or a touch panel, and provides the acquired information to the computer 30. Furthermore, the external device 9A or the external device 9B may be a device or the like including an input unit, a memory, and a processor, such as a personal computer, a tablet terminal, or a smartphone.

Furthermore, the external device 9A or the external device 9B may be an output device (output unit) as an example. The output device may be, for example, a display device (display unit) such as a liquid crystal display (LCD), a cathode ray tube (CRT), a plasma display panel (PDP), or an organic electro luminescence (EL) panel, or may be a speaker that outputs sound or the like. Furthermore, the external device 9A or the external device 9B may also be a device such as a personal computer, tablet terminal, or smartphone, which includes an output device, a memory, and a processor.

Furthermore, the external device 9A or the external device 9B may be a storage device (memory). For example, the external device 9A may be a network storage or the like, and the external device 9B may be a storage such as an HDD.

Furthermore, the external device 9A or the external device 9B may be a device having some functions of the components of the inference device 1 in the present embodiment. That is, the computer 30 may transmit or receive a part or all of the processing result of the external device 9A or the external device 9B.

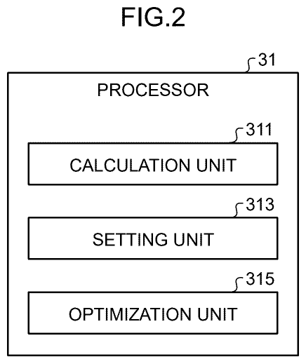

FIG. 2 is a diagram illustrating an example of functional blocks in the processor 31. The processor 31 includes, for example, a calculation unit 311, a setting unit 313, and an optimization unit 315 as functions realized by the processor 31. The functions implemented by the calculation unit 311, the setting unit 313, and the optimization unit 315 are stored as programs in, for example, the main storage device 33 or the auxiliary storage device 35. The processor 31 can implement functions related to the calculation unit 311, the setting unit 313, and the optimization unit 315 by reading and executing a program stored in the main storage device 33, the auxiliary storage device 35, or the like. The calculation unit 311 may be referred to as an arithmetic unit. Furthermore, the calculation unit 311 and the optimization unit 315 may be collectively referred to as a computation unit.

The calculation unit 311 may generate a three-dimensional atomic structure based on the information regarding SMILES (hereinafter referred to as SMILES information) input by the input device. The atomic structure corresponds to an arrangement of atoms in which a plurality of atoms related to a substance indicated by SMEILES notation are three-dimensionally arranged. The calculation unit 311 generates an atomic structure by inputting SMEILES notation to a neural network (hereinafter referred to as a neural network potential (NNP)) that approximates potential energy that is a function of coordinates of an atom. For example, the NNP corresponds to a neural network that executes physical simulation with an atomic structure as information indicating a physical system, which is an inference target, and outputs an energy value related to the atomic structure as an output value. In addition, not only the energy value itself but also a value obtained by performing the four arithmetic operations such as multiplying the energy value as the output of the neural network by a certain value or a value obtained by performing other arithmetic operations on the energy value may be used, and such a value is referred to as a score including the output value of the neural network.

Since a known technique can be appropriately used for the processing of generating the atomic structure based on the SMILES information, the description thereof will be omitted. The NNP has high versatility, being capable of generating energy values with good precision for various atomic structures. The NNP may be referred to as a learned model or a learned neural network. That is, the neural network used by the calculation unit 311 may be a learned NNP. Note that the learned model is not limited to the NNP, and another learned neural network may be used.

The calculation unit 311 may calculate an output value from the neural network by inputting information indicating the physical system, which is an inference target, to the physical simulation using the neural network. For example, the calculation unit 311 may input the generated atomic structure to a learned neural network (NNP) to generate an energy value (output value) corresponding to the atomic structure. The output value is output from a learned neural network as a scalar function, for example. The calculation unit 311 may store the generated energy value in the main storage device 33 or the auxiliary storage device 35. The learned neural network may be learned in advance and stored in the main storage device 33 or the auxiliary storage device 35. Since a known technique can be appropriately used for the generation of the energy value by the neural network (NNP) using the atomic structure, the description thereof will be omitted.

Furthermore, the calculation unit 311 may calculate the derivative of the output value (hereinafter referred to as derivative value) by applying back propagation to the neural network. For example, the calculation unit 311 computes a derivative value corresponding to the output value by performing back propagation in the neural network using the output value. When the output value is a scalar function using coordinates as an argument, the derivative value corresponds to a coordinate derivative of the scalar function. Specifically, in a case where the output value is an energy value, the calculation unit 311 may calculate a force corresponding to the energy value by back propagation of a neural network using the energy value. The calculation unit 311 may store the calculated derivative value (the derivative of the output value, force) in the main storage device 33 or the auxiliary storage device 35. Since a known method can be appropriately used for the calculation of the force (the derivative of the energy value) by back propagation of the neural network (NNP) using the atomic structure, the description thereof will be omitted. Note that an example of computing the derivative value using the output value of the neural network as the score will be described below, but the score may be computed from the output value of the neural network to compute the derivative value of the score.

The setting unit 313 may set the search condition for the optimal solution of the output value using the index indicating the uncertainty of the output value, the derivative of the output value, and the output value. The index indicating the uncertainty of the output value may be set in advance according to the information indicating the physical system, which is an inference target, and the precision of the floating-point number related to the calculation of the output value. Specifically, the index may be set in advance according to the precision of the floating-point number when the output value is calculated, the characteristics of the neural network, the dimension of the output value, and the like, and may be stored in the main storage device 33 or the auxiliary storage device 35. That is, the index is a parameter determined by the user based on the possible uncertainty. Note that the index indicating the uncertainty of the output value may be referred to as noise, error, or the like.

For example, the setting unit 313 sets the search condition by adding the index to the output value in the Armijo condition. The Armijo condition is a condition used when an objective function that realizes a maximum value or a minimum value is searched for by a gradient method. For example, in a case where the information indicating the physical system, which is an inference target, is an atomic structure and the neural network is an NNP, the objective function is a scalar function indicating energy. At this time, the search condition is used to search for a scalar function having the minimum energy value (in other words, energy optimization for the atomic structure).

As the gradient method, for example, a quasi-Newton method using a line search is used. As the quasi-Newton method, for example, a Broyden-Fletcher-Goldfarb-Shanno (BFGS) method or the like may be used. Since the quasi-Newton method, the BFGS method, and the like are known techniques, the description thereof will be omitted. The Armijo condition is represented by, for example, the following Formula (1).

$$f ( {x}_{k} + α {p}_{k} ) \leq f ( {x}_{k} ) + {c}_{1} α ∇ {f}_{k}^{T} {p}_{k} \qquad ( 1 )$$

In Formula (1), f corresponds to a scalar function that is an output value output from the neural network. In addition, pk in Formula (1) corresponds to a search direction in which a search is performed such that the scalar function f has a minimum value. xₖ in Formula (1) corresponds to an argument (position) of the scalar function f (when the neural network is NNP, the energy according to the position). c₁ in Formula (1) is a value between 0 and 1, and may be set in advance.

The setting unit 313 may set the search condition by adding an index to the Armijo condition using the derivative of the output value and the output value. When the index is expressed by ε, the setting unit 313 may add the index ε to the right side of the Armijo condition of Formula (1) to set the search condition represented by the following Formula (2).

$$f ( {x}_{k} + α {p}_{k} ) \leq ( f ( {x}_{k} ) + ε ) + {c}_{1} α ∇ {f}_{k}^{T} {p}_{k} \qquad ( 2 )$$

The setting unit 313 may store the set search condition (Formula (2)) in the main storage device 33 or the auxiliary storage device 35. Adding the index ε to Formula (1), which is the Armijo condition, corresponds to relaxing the Armijo condition. The search condition is not limited to Formula (2), and as an application example of the present embodiment, for example, may further include high-order derivatives (second-order derivative, third-order derivative, and the like) of the output value f. In addition to Formula (2), the Wolfe condition expressed by the following Formula (3) may be set.

$$∇ f ( {x}_{k} + α {p}_{k} ) {}^{T} {p}_{k} \geq {c}_{2} ∇ {f}_{k}^{T} {p}_{k} \qquad ( 3 )$$

c₂ in Formula (3) is a value between c₁ and 1, and may be set in advance. The definitions of the other symbols in Formula (3) are the same as those in Formulae (1) and (2).

For example, in the distribution of the output values (for example, energy distribution), a variation of ten times or more of the double single-precision floating-point number (FP64) may appear in the single-precision floating-point number (FP32). For these reasons, it is possible to optimize the energy distribution with the double single-precision floating-point number (FP64), but it is difficult to optimize the energy distribution with the single-precision floating-point number (FP32).

On the other hand, it is known that the distribution (force distribution) of the derivative value ∇f of the output value calculated by back propagation to the neural network is comparable to the double single-precision floating-point number (FP64) even for the single-precision floating-point number (FP32). That is, when the output value output from the neural network includes a numerical computation error corresponding to uncertainty, it is experimentally known that precision of gradient information (the derivative of the output value) obtained by an error back propagation method for the neural network is relatively higher than precision of the output value.

The search condition set by the setting unit 313 indicates that the restriction based on the output value is relaxed in the line search, as shown in Formula (2). In other words, the search condition indicates that the derivative value is more reliable than the output value, that is, the derivative value with high precision is more important than the output value with low precision. More specifically, the search condition shown in Formula (2) indicates that a difference of a certain width (f+ε) or more is treated as a significant difference in the line search.

The optimization unit 315 determines the optimal solution of the output value by applying the gradient method using the search condition to the output value. For example, the optimization unit 315 executes the BFGS method on the output value using the search condition, and calculates the optimal value of the output value. Specifically, for example, in a case where the information indicating the physical system, which is an inference target, is an atomic structure and the neural network is an NNP, the optimization unit 315 searches for the scalar function f having the minimum energy value as the output value. As a result, the optimization unit 315 executes optimization of the output value, that is, minimization of energy.

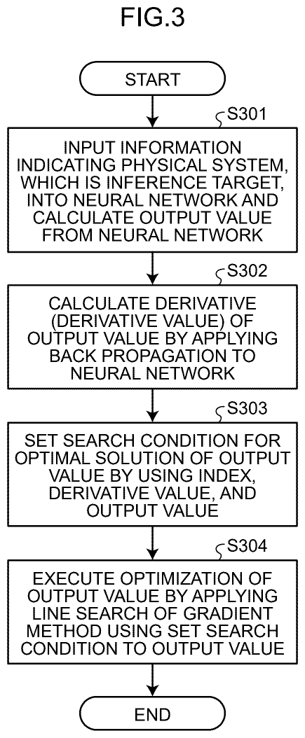

The configuration of the inference device 1 has been described above. Hereinafter, processing of optimizing the output value by the inference device 1 (hereinafter referred to as optimization processing) will be described with reference to FIG. 3.

FIG. 3 is a flowchart illustrating an example of a procedure of the optimization processing.

### Optimization Processing

### Step S301

The calculation unit 311 may input information indicating the physical system, which is an inference target, into the neural network and calculate an output value from the learned neural network. Specifically, the calculation unit 311 may input SMILES information to NNP to generate an atomic structure. Next, the calculation unit 311 may input the generated atomic structure to NNP and calculate the energy value as the output value. The distribution of the energy values corresponds to a scalar function f. The calculation unit 311 may store the distribution of the calculated energy values in the main storage device 33 or the auxiliary storage device 35 in association with the generated atomic structure.

### Step S302

The calculation unit 311 may calculate the derivative (derivative value: ∇f) of the output value by applying back propagation to the neural network using the output value. The calculation unit 311 may store the calculated derivative value in the main storage device 33 or the auxiliary storage device 35 in association with the generated atomic structure.

### Step S303

The setting unit 313 may set a search condition for an optimal solution of the output value using the index &, the derivative value ∇f, and the output value f. Specifically, the setting unit 313 may read the preset index E, the derivative value ∇f, and the output value f from the main storage device 33 or the auxiliary storage device 35. Next, the setting unit 313 may set Formula (2), which is the search condition, by adding the index ε to Formula (1) indicating the Armijo condition. Formula (3) indicating the Wolfe condition may be set.

### Step S304

The optimization unit 315 may execute the optimization of the output value by applying the line search of the gradient method using the set search condition to the output value. That is, the optimization unit 315 may calculate the minimum output value f (x), for example, by executing the line search using the search condition on the output value f. Since a known procedure can be applied to the computation technique related to the line search, the description thereof will be omitted.

From the above, the inference device 1 according to the present embodiment may calculate the output value f from the neural network by inputting information indicating the physical system, which is an inference target, to the physical simulation using the neural network, may calculate the derivative f′ of the output value f by applying back propagation to the neural network, may set the search condition (Formula (2)) of the optimal solution of the output value f by using the index ε indicating the uncertainty of the output value f, the derivative f′ of the output value f, and the output value f, and may determine the optimal solution of the output value f by applying the gradient method using the search condition (Formula (2)) to the output value f.

Furthermore, in the inference device 1 according to the present embodiment, the search condition may be set by adding the index ε to the output value f under the Armijo condition. Furthermore, in the inference device 1 according to the present embodiment, the index ε may be set in advance according to the information indicating the physical system, which is an inference target, and the precision of the floating-point number related to the calculation of the output value f. Furthermore, in the inference device 1 according to the present embodiment, the neural network may be a learned neural network potential (NNP). In the inference device 1 according to the present embodiment, the gradient method using the search condition may be a line search. Furthermore, in the inference device 1 according to the present embodiment, the information indicating the physical system, which is an inference target, may be information indicating an atomic structure. Furthermore, in the inference device 1 according to the present embodiment, the output value may be represented by a scalar function.

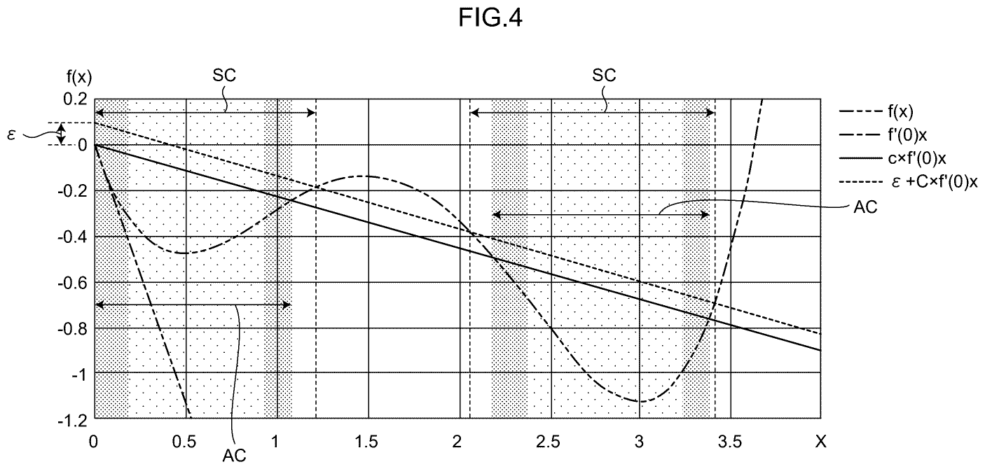

FIG. 4 is a diagram illustrating an example of a range AC of the Armijo condition and a range SC of the search condition in the line search. In FIG. 4, the range SC of the search condition is wider than the range AC of the Armijo condition due to the index ε. As illustrated in FIG. 4, when the line search is performed, the step size may be independently determined after the determination of the search direction. According to the inference device 1 according to the present embodiment, in the line search, it is guaranteed to proceed steadily toward the stable point, and thus, it is possible to improve robustness of optimization as compared with other algorithms in which there is no proof of convergence and there is always a risk of divergence.

For example, in the single-precision floating-point number (FP32), since the output value includes more uncertainty than the derivative value, in other words, since more noise than the derivative value is mixed in the output value, the optimization computation using the BFGS method to which the Armijo condition (Formula (1)) is applied may fail. However, according to the inference device 1 according to the present embodiment, it is possible to execute line search using the fact that the derivative f′ of the output value computed by back propagation with respect to the neural network has higher precision than the output value f.

Specifically, according to the inference device 1 according to the present embodiment, in order to trust the derivative f′ of the output value more than the output value f, a search condition obtained by adding the index of uncertainty to the output value f in the Armijo condition may be set. The search condition (Formula (2)) may be set by adding the index ε to the right side of the Armijo condition (Formula (1)) to relax the Armijo condition (Formula (1)) and also allow a constant increase due to the uncertainty of the output value f. In the line search using the search condition (Formula (2)), the value (f+ε) obtained by adding the uncertainty index ε to the output value f is treated as a significant difference in the line search.

According to the inference device 1 according to the present embodiment, for example, in a case where a line search in a gradient method is executed using a search condition for a scalar function f that is an output value from a neural network, a gradient of the function (the derivative f′ of the output value) is 0 at a minimum point, and information of the gradient of the scalar function f (the derivative f′ of the output value) is used for finding and determining the minimum point. Therefore, according to the inference device 1 according to the present embodiment, even when the value of the scalar function f contains uncertainty (noise), the information of the gradient (the derivative f′ of the output value) of the scalar function f is reliable, and thus the minimum point can be searched for.

Therefore, according to the inference device 1 according to the present embodiment, even when the uncertainty is included in the value (output value) of the function output from the neural network, the search does not fail, and the optimization computation can be normally ended. That is, according to the inference device 1 precision to the present embodiment, it is possible to realize optimization of an output value with high precision even when precision of the output value from a neural network is low. For example, by setting a search condition in accordance with the nature of the neural network, that is, in accordance with the uncertainty of the output value output from the neural network, even when computation is performed with a single-precision floating-point number (FP32), optimization computation can be realized with computation precision with a double single-precision floating-point number (FP64).

As described above, according to the inference device 1 according to the present embodiment, in a case where an output value is output using a neural network and the derivative of the output value is calculated by back propagation with respect to the neural network, optimization calculation of the output value can be realized in a short time and with high precision by using a floating point with a high computation speed. Note that, as an application example of the present embodiment, in a case where an output value is output using a neural network and the derivative of the output value is computed by back propagation with respect to the neural network, the technical features of the present embodiment are applicable. Note that the optimization processing according to the present embodiment is not limited to the BFGS method, and can be similarly executed in other gradient techniques by applying a modification that allows an increase in the index ε indicating the uncertainty of the output value to the condition using the output value from the neural network.

When the technical idea in the embodiment is realized by an inference method, the inference method may calculate an output value from a neural network by inputting information indicating a physical system, which is an inference target, to physical simulation using the neural network, may calculate the derivative of the output value by applying back propagation to the neural network, may set a search condition for an optimal solution of the output value by using an index ε indicating uncertainty of the output value, the derivative of the output value, and the output value, or may determine the optimal solution of the output value by applying a gradient method using the search condition to the output value. Since the procedure and effect of the optimization processing regarding the inference method are similar to those described in the embodiment, the description thereof will be omitted.

When the technical idea in the embodiment is realized by an inference program, the inference program that causes a computer to execute calculating an output value from a neural network by inputting information indicating a physical system, which is an inference target, to physical simulation using the neural network, calculating the derivative of the output value by applying back propagation to the neural network, setting a search condition for an optimal solution of the output value by using an index ε indicating uncertainty of the output value, the derivative of the output value, and the output value, or determining the optimal solution of the output value by applying a gradient method using the search condition to the output value.

For example, the optimization processing can also be realized by installing the inference program in a computer in various simulation devices, server devices, or the like that execute physical simulation using a neural network and developing the inference program on a memory. At this time, the program that can cause the computer to execute the inference technique can also be distributed by being stored in a storage medium such as a magnetic disk (hard disk or the like), an optical disk (CD-ROM, DVD, and the like), or a semiconductor memory. Since the procedure and effect of the optimization processing by the inference program are similar to those of the embodiment, the description thereof will be omitted.

Some or all of the devices in the above-described embodiments may be configured by hardware, or may be configured by information processing of software (program) executed by a CPU, a GPU, or the like. In the case of being configured by information processing of software, the information processing of software may be executed by storing software that realizes at least some functions of each device in the above-described embodiments in a non-transitory storage medium (non-transitory computer readable medium) such as a flexible disk, a compact disc-read only memory (CD-ROM), or a USB memory and causing the computer 30 to read the software. In addition, the software may be downloaded via the communication network 5. Furthermore, information processing may be executed by hardware by implementing software in a circuit such as an ASIC or an FPGA.

The type of the storage medium storing the software is not limited. The storage medium is not limited to a removable storage medium such as a magnetic disk or an optical disk, and may be a fixed storage medium such as a hard disk or a memory. Furthermore, the storage medium may be provided inside the computer or may be provided outside the computer.

In the present specification (including claims), the expression “at least one of a, b, and c (one)” or “at least one of a, b, or c (one)” (including similar expressions) includes any of a, b, c, a-b, a-c, b-c, or a-b-c. In addition, a plurality of instances may be included for any element, such as a-a, a-b-b, a-a-a-b-b-c-c, and the like. Furthermore, the addition of other elements other than the listed elements (a, b, and c), such as having d as a-b-c-d, is also included.

In the present specification (including claims), a case where an expression such as “using data as input/based on data/according to data/in accordance with data” (including similar expression) is used, includes a case where various types of data themselves are used as input, and a case where data obtained by performing some processing on various data (for example, noise addition, normalization, intermediate representation of various types of data, and the like) is used as input, unless otherwise specified. Furthermore, a case where it is described that any result is obtained “based on/according to/in accordance with data”, a case where the result is obtained based on only the data is included, and a case where the result is obtained under the influence of other data other than the data, factors, conditions, states, and/or the like, may also be included. In addition, a case where “outputting data” is described, a case where there is no particular description, a case where various types of data themselves are used as output, and a case where data obtained by performing some processing on various types of data (for example, noise addition, normalization, intermediate representation of various data, and the like) is output, are also included.

In the present specification (including claims), the terms “connected” and “coupled” are intended as non-limiting terms, including any of direct connection/coupling, indirect connection/coupling, electrical connection/coupling, communicative connection/coupling, operative connection/coupling, physical connection/coupling, and the like. The term should be interpreted accordingly depending on the context in which the term is used, but connection/coupling forms which are not intentionally or naturally excluded should be interpreted in a non-limiting manner as included in the term.

In the present specification (including claims), when the expression “A configured to B” is used, the physical structure of the element A may have a configuration capable of executing the operation B, and a permanent or temporary setting/configuration of the element A may be configured/set to actually execute the operation B. For example, in a case where the element A is a general-purpose processor, the processor may have a hardware configuration capable of executing the operation B, and may be configured to actually execute the operation B by setting a permanent or temporary program (instruction). Furthermore, in a case where the element A is a dedicated processor, a dedicated arithmetic circuit, or the like, regardless of whether or not the control command and the data are actually attached, the circuit structure of the processor may be implemented to actually execute the operation B.

In the present specification (including claims), the use of the term (for example, “comprising/including” “having”, and the like) meaning containing or possessing is intended as open-ended terms including the case of containing or possessing an object other than the object indicated by the object of the term. In a case where the object of these terms meaning inclusion or possession is an expression that does not specify a quantity or suggests a singular (expression with the article “a” or “an”), such an expression should be interpreted as not being limited to a specific number.

In the present specification (including claims), even when an expression such as “one or more” or “at least one” is used in one place and an expression not specifying a quantity or implying a singular number (an expression with an article) is used in another place, the latter expression is not intended to mean “one”. In general, expressions that do not specify a quantity or suggest a singular (expressions with the article “a” or “an”) should be interpreted as not necessarily being limited to a specific number.

In the present specification, in a case where it is described that a specific effect (advantage/result) is obtained for a specific configuration of a certain embodiment, it should be understood that the effect is also obtained for one or more other embodiments having the configuration unless otherwise stated. However, the presence or absence of the effect generally depends on various factors, conditions, and/or states, and it should be understood that the effect is not necessarily obtained by the configuration. The effect is obtained only by the configuration described in Examples when various factors, conditions, and/or states are satisfied, and the effect is not necessarily obtained in the claimed invention defining the configuration or similar configuration.

The use of the term “maximize” or the like in the present specification (including claims) includes determining a global maximum, determining an approximation of the global maximum, determining a local maximum, and determining an approximation of the local maximum, and should be interpreted accordingly depending on the context in which the term is used. The method also includes stochastically or heuristically obtaining an approximate value of these maximum values. Similarly, the use of terms such as “minimize” includes determining a global minimum, determining an approximation of the global minimum, determining a local minimum, and determining an approximation of the local minimum, and should be interpreted accordingly depending on the context in which the term is used. The method also includes stochastically or heuristically obtaining an approximate value of these minimum values. Similarly, the use of terms such as “optimize” includes determining a global optimal value, determining an approximation of the global optimal value, determining a local optimal value, and determining an approximation of the local optimal value, and should be interpreted accordingly depending on the context in which the term is used. The method also includes stochastically or heuristically obtaining an approximate value of these optimal values.

In the present specification (including claims), in a case where a plurality of pieces of hardware performs predetermined processing, the pieces of hardware may perform the predetermined processing in cooperation with each other, or some pieces of hardware may perform all of the predetermined processing. In addition, some hardware may perform a part of the predetermined processing, and another hardware may perform the rest of the predetermined processing. In the present specification (including claims), in a case where an expression such as “wherein one or more pieces of hardware perform first processing, and the one or more pieces of hardware perform second processing” is used, the hardware that performs the first processing and the hardware that performs the second processing may be the same or different. To sum up, hardware that performs the first processing and hardware that performs the second processing may be included in the one or more pieces of hardware. Note that the hardware may include an electronic circuit or a device including an electronic circuit.

In the present specification (including claims), when a plurality of storage devices (memories) store data, each storage device (memory) among the plurality of storage devices (memories) may store only a part of the data or may store the entire data.

Although the embodiments of the present disclosure have been described in detail above, the present disclosure is not limited to the individual embodiments described above. Various additions, modifications, substitutions, partial deletions, and the like can be made without departing from the conceptual idea and gist of the present invention derived from the contents defined in the claims and equivalents thereof. For example, in all the embodiments described above, when a numerical value or a mathematical expression is used for description, it is shown as an example, and the embodiment is not limited thereto. Furthermore, the order of each operation in the embodiment is illustrated as an example, and the present invention is not limited thereto.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Regarding the above embodiments and the like, the following supplementary notes are disclosed as one aspect and selective features of the invention.

### (Note 1)

An inference device including:
at least one memory; and
at least one processor, wherein
the at least one processor:
   outputs a score by using a neural network;
   calculates a derivative value of the score by applying back propagation to the neural network;
   sets a search condition for an optimal solution of the score by using an index indicating an uncertainty of the score, the derivative value of the score, and the score; and
   determines an optimal solution of the score by a gradient method using the search condition.

### (Note 2)

The inference device according to Note 1, wherein
the search condition is set by adding the index to a right side of an Armijo condition indicated by

$$f ( {x}_{k} + α {p}_{k} ) \leq f ( {x}_{k} ) + {c}_{1} α ∇ {f}_{k}^{T} {p}_{k} .$$

### (Note 3)

The inference device according to Note 2, wherein
the search condition is set by a Wolfe condition in addition to the Armijo condition.

### (Note 4)

The inference device according to Note 1, wherein
the score is output by inputting, to the neural network, information indicating a physical system, which is an inference target of the inference device.

### (Note 5)

The inference device according to Note 1, wherein
the index is set according to information indicating an inference target of the inference device and precision of a floating-point number related to calculation of the score.

(Note 6)

The inference device according to Note 1, wherein
the gradient method using the search condition is a line search.

### (Note 7)

The inference device according to Note 4, wherein
the information indicating the physical system, which is the inference target, is information of an atomic structure.

### (Note 8)

The inference device according to Note 1, wherein
the score is represented by a scalar function.

### (Note 9)

The inference device according to Note 1, wherein
the search condition further includes a high-order derivative of the score.

### (Note 10)

The inference device according to any one of Notes 1 to 9, wherein
the neural network is a learned neural network potential.

What is claimed is:

1. A device comprising:
at least one memory; and
at least one processor, wherein
the at least one processor is configured to:
generate a score by using a neural network;
calculate a derivative value of the score by applying back propagation to the neural network;
set a search condition for an optimal solution of the score by using an index indicating an uncertainty of the score, the derivative value of the score, and the score; and
determine the optimal solution of the score by a gradient method using the search condition.

2. The device according to claim 1, wherein
the search condition is set by adding the index to a right side of an Armijo condition indicated by
$$f ( {x}_{k} + α {p}_{k} ) \leq f ( {x}_{k} ) + {c}_{1} α ∇ {f}_{k}^{T} {p}_{k} .$$

3. The device according to claim 2, wherein
the search condition is set by a Wolfe condition in addition to the Armijo condition.

4. The device according to claim 1, wherein
the score is generated by inputting, to the neural network, information indicating a physical system, which is an inference target of the device.

5. The device according to claim 1, wherein
the index is set according to information indicating an inference target of the device and precision of a floating-point number related to the generation of the score.

6. The device according to claim 1, wherein
the gradient method using the search condition is a line search.

7. The device according to claim 4, wherein
the information indicating the physical system, which is the inference target, is information of an atomic structure.

8. The device according to claim 1, wherein
the score is represented by a scalar function.

9. The device according to claim 1, wherein
the search condition further includes a high-order derivative of the score.

10. The device according to claim 1, wherein
the neural network is a learned neural network potential.

11. A method comprising:
generating, by one or more processors, a score by using a neural network;
calculating, by the one or more processors, a derivative value of the score by applying back propagation to the neural network;
setting, by the one or more processors, a search condition for an optimal solution of the score by using an index indicating an uncertainty of the score, the derivative value of the score, and the score; and
determining, by the one or more processors, the optimal solution of the score by a gradient method using the search condition.

12. The method according to claim 11, wherein
the search condition is set by adding the index to a right side of an Armijo condition indicated by
$$f ( {x}_{k} + α {p}_{k} ) \leq f ( {x}_{k} ) + {c}_{1} α ∇ {f}_{k}^{T} {p}_{k} .$$

13. The method according to claim 12, wherein
the search condition is set by a Wolfe condition in addition to the Armijo condition.

14. The method according to claim 11, wherein
the score is generated by inputting, to the neural network, information indicating a physical system, which is an inference target of the device.

15. The method according to claim 11, wherein
the index is set according to information indicating an inference target of the device and precision of a floating-point number related to the generation of the score.

16. The method according to claim 11, wherein
the gradient method using the search condition is a line search.

17. The method according to claim 14, wherein
the information indicating the physical system, which is the inference target, is information of an atomic structure.

18. The method according to claim 11, wherein
the score is represented by a scalar function.

19. The method according to claim 11, wherein
the search condition further includes a high-order derivative of the score.

20. A non-transitory computer-readable storage medium for storing a program that, when executed by one or more processors of one or more computers, cause the one or more computers to:
generate a score by using a neural network;
calculate a derivative value of the score by applying back propagation to the neural network;
set a search condition for an optimal solution of the score by using an index indicating an uncertainty of the score, the derivative value of the score, and the score; and
determine the optimal solution of the score by a gradient method using the search condition.
